(19) United States
(12) Patent Application Publication
(10) Pub. No.: US 2026/0264732 A1
(43) Pub. Date: Sep. 10, 2026

(54) COLLAPSIBLE CART AND STORAGE COMPARTMENT SYSTEM

(71) Applicant: Branden Kosciesza, West Bend, WI (US)

(72) Inventor: Branden Kosciesza, West Bend, WI (US)

(21) Appl. No.: 19/072,040

(22) Filed: Mar. 6, 2025

(51) Int. Cl. B62B 5/00; B62B 3/00; B62B 3/02; B62B 5/06

(52) U.S. Cl. CPC B62B 5/0003; B62B 3/005; B62B 3/022; B62B 5/06

(57) ABSTRACT

A material handling system for collapsing while supporting a load such that the load may be easily set into a vehicle includes an upper platform, a pair of linkages, and a plurality of wheels. The linkages couple the upper platform to the wheels and are movable between a deployed configuration and a collapsed configuration. The cart stands upright on the wheels when the linkages are in the deployed configuration, and the cart is compacted when the linkages are in the collapsed configuration. The linkages are biased toward the deployed configuration and are lockable such that they are fixed against changing configuration. The cart may be stored in a receiver when the linkages are in the collapsed configuration so that the cart is secured to a vehicle or other destination structure while the cart supports the load on the upper platform.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to collapsible carts and more particularly pertains to a new collapsible cart for collapsing while supporting a load such that the load may be easily set into a vehicle.

### (2) Description of Related Art Including Information Disclosed Under 37 CFR 1.97 and 1.98.

The prior art discloses myriad collapsible carts for holding a load while collapsing the cart such that the load may be brought into or out of a vehicle. However the prior art fails to describe such an apparatus which comprises two linkages that connect a set of wheels to a platform, each linkage comprising a first leg which pivotably attaches to the platform, a second leg which has two segments that pivot with respect to each other and which pivotably attaches to the platform, and a cross link which pivots on the second leg and slides along the first leg.

### (H) BRIEF SUMMARY OF THE INVENTION

An embodiment of the disclosure meets the needs presented above by generally comprising a cart which is configured to collapse while continuing to carry a load. The cart comprises an upper platform, a pair of linkages, and a plurality of wheels. The linkages are coupled to and extend between the upper platform and the wheels. The linkages are movable between deployed configurations and collapsed configurations.

The upper platform has a front side and a back side positioned opposite each other. A bottom side and a top side of the upper platform extend between the front side and the back side. A pair of lateral sides of the upper platform extend between the front side and the back side and between the bottom side and the top side. The upper platform comprises a base wall and a perimeter wall coupled to the base wall. The upper platform defines a cavity surrounded by the base wall and the perimeter wall. The load may be set atop the base wall of the upper platform. In some embodiments, the upper platform may not define the cavity and may instead simply have an upper surface upon which to set the load.

The linkages are attached to the bottom side of the upper platform and are laterally spaced from each other with respect to the upper platform. Each linkage comprises a top front link, a bottom front link, a back link, and a bottom link. The top front link is mounted to the bottom side of the upper platform at a front platform pivot and is pivotable alternately forward and backward with respect to the upper platform about the front platform pivot. The bottom front link is coupled to the top front link opposite the upper platform at a front leg pivot and is pivotable forward and backward with respect to the upper platform about the front leg pivot. The back link is mounted to the bottom side of the upper platform at a back platform pivot which is spaced backwardly of the front platform pivot with respect to the upper platform.

The back link is pivotable alternately forward and backward with respect to the upper platform about the back platform pivot. The bottom link is coupled to and extends between the back link and the bottom front link. The bottom link is pivotable with respect to the bottom front link at a bottom pivot. A rear portion of the bottom link defines a slider which is slidable along a length of the back link between a proximal position and a distal position with respect to the upper platform. The slider slides along the back link via a pin inserted in a slot defined by the back link.

Each linkage is movable between the deployed configuration and the collapsed configuration. When one of the linkages is in the deployed configuration, the top front link extends downwardly from the upper platform, the bottom front link extends downwardly from the top front link with respect to the upper platform, the back link extends downwardly from the upper platform, and the slider of the bottom link is positioned in the distal position. Stops, detents, spring-biased lock pins, or the like may be used to prevent the top front links from pivoting forwardly with respect to the upper platform beyond their orientation in the deployed configuration.

When one of the linkages is in the collapsed configuration, the top front link lies along the bottom side of the upper platform, the bottom front link lies closely to the upper platform, the back link lies closely to the bottom front link, and the slider of the bottom link is positioned in the proximal position. The top front link extends backwardly with respect to the upper platform from the front platform pivot to the front leg pivot, the bottom front link extends forwardly with respect to the upper platform from the front leg pivot to the bottom pivot, and the back link extends forwardly with respect to the upper platform from the back platform pivot to a distal end of the back link with respect to the upper platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a cart of a material handling system according to an embodiment of the disclosure in which each linkage of a pair of linkages is positioned in a deployed configuration. Only one linkage is shown, but the other linkage is of the same structure as the one linkage.

FIG. 2 is a side view of a cart of an embodiment of the disclosure in which each linkage of a pair of linkages is positioned in a transition state between a deployed configuration and a collapsed configuration. Only one linkage is shown, but the other linkage is of the same structure as the one linkage.

FIG. 3 is a side view of a cart of an embodiment of the disclosure in which each linkage of a pair of linkages is positioned in a collapsed configuration. Only one linkage is shown, but the other linkage is of the same structure as the one linkage.

FIG. 4 is a top view of a cart of an embodiment of the disclosure.

FIG. 5 is a back view of a cart of an embodiment of the disclosure.

FIG. 6 is a front view of a cart of an embodiment of the disclosure.

FIG. 7 is an in-use view of an embodiment of the disclosure.

FIG. 8 is an in-use view of an embodiment of the disclosure.

### (J) DETAILED DESCRIPTION OF THE INVENTION

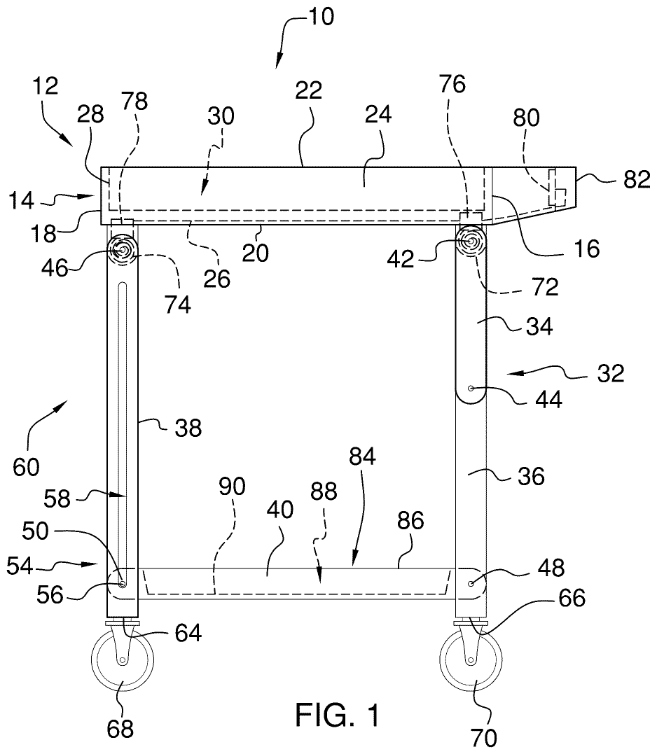

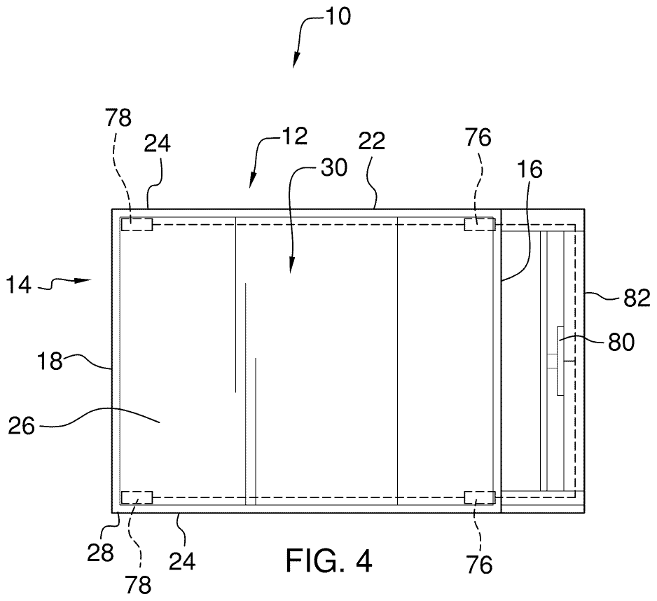

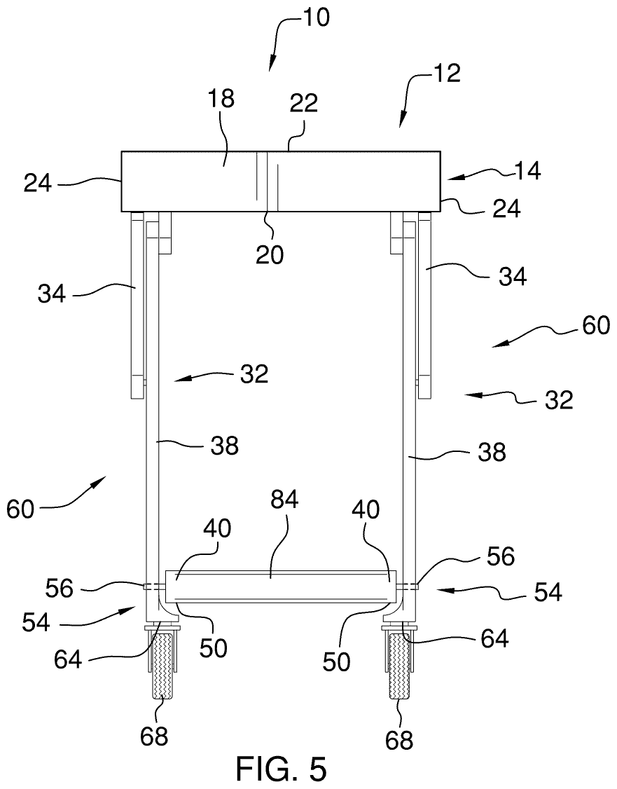

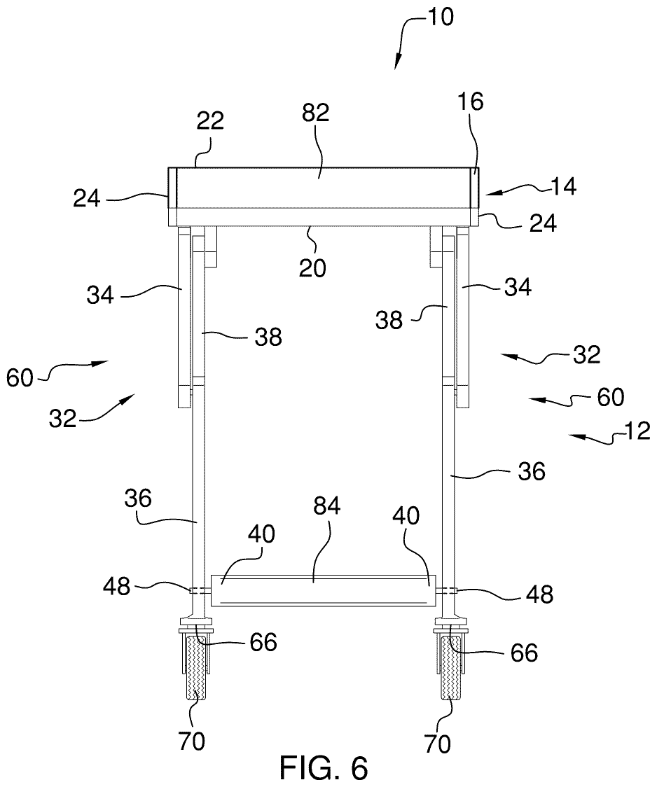

With reference now to the drawings, and in particular to FIGS. 1 through 8 thereof, a new collapsible cart embodying the principles and concepts of an embodiment of the disclosure and generally designated by the reference numeral 10 will be described.

As best illustrated in FIGS. 1 through 8, the material handling system 10 generally comprises a cart 12 which is configured to collapse while continuing to carry a load 106 and a receiver for holding the cart 12 when the cart 12 has been collapsed. The cart 12 comprises an upper platform 14, a pair of linkages 32, and a plurality of wheels. The linkages 32 are coupled to and extend between the upper platform 14 and the wheels. The linkages 32 are movable between deployed configurations 60 and collapsed configurations 62.

The upper platform 14 has a front side 16 and a back side 18 positioned opposite each other. A bottom side 20 and a top side 22 of the upper platform 14 extend between the front side 16 and the back side 18. A pair of lateral sides 24 of the upper platform 14 extend between the front side 16 and the back side 18 and between the bottom side 20 and the top side 22. The upper platform 14 comprises a base wall 26 and a perimeter wall 28 coupled to the base wall 26. The upper platform 14 defines a cavity 30 surrounded by the base wall 26 and the perimeter wall 28. The load 106 may be set atop the base wall 26 of the upper platform 14. In some embodiments, the upper platform 14 may not define the cavity 30 and may instead simply have an upper surface upon which to set the load 106.

The linkages 32 are attached to the bottom side 20 of the upper platform 14 and are laterally spaced from each other with respect to the upper platform 14. Each linkage 32 comprises a top front link 34, a bottom front link 36, a back link 38, and a bottom link 40. The top front link 34 is mounted to the bottom side 20 of the upper platform 14 at a front platform pivot 42 and is pivotable alternately forward and backward with respect to the upper platform 14 about the front platform pivot 42. The bottom front link 36 is coupled to the top front link 34 opposite the upper platform 14 at a front leg pivot 44 and is pivotable forward and backward with respect to the upper platform 14 about the front leg pivot 44. The back link 38 is mounted to the bottom side 20 of the upper platform 14 at a back platform pivot 46 which is spaced backwardly of the front platform pivot 42 with respect to the upper platform 14.

The back link 38 is pivotable alternately forward and backward with respect to the upper platform 14 about the back platform pivot 46. The bottom link 40 is coupled to and extends between the back link 38 and the bottom front link 36. The bottom link 40 is pivotable with respect to the bottom front link 36 at a bottom pivot 48. A rear portion of the bottom link 40 defines a slider 50 which is slidable along a length of the back link 38 between a proximal position 52 and a distal position 54 with respect to the upper platform 14. The slider 50 slides along the back link 38 via a pin 56 inserted in a slot 58 defined by the back link 38.

Each linkage 32 is movable between the deployed configuration 60 and the collapsed configuration 62. As shown in FIG. 1, when one of the linkages 32 is in the deployed configuration 60, the top front link 34 extends downwardly from the upper platform 14, the bottom front link 36 extends downwardly from the top front link 34 with respect to the upper platform 14, the back link 38 extends downwardly from the upper platform 14, and the slider 50 of the bottom link 40 is positioned in the distal position 54. Stops, detents, spring-biased lock pins, or the like may be used to prevent the top front links 34 from pivoting forwardly with respect to the upper platform 14 beyond their orientation in the deployed configuration 60.

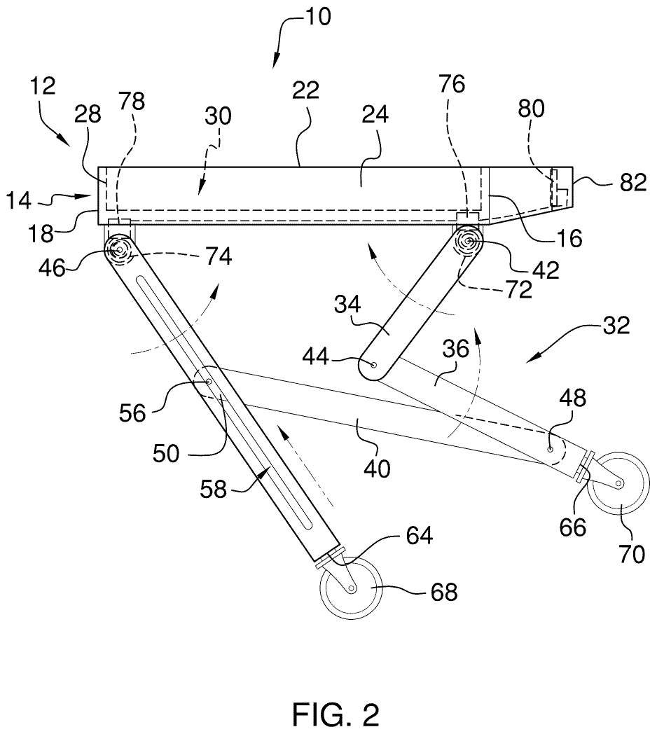

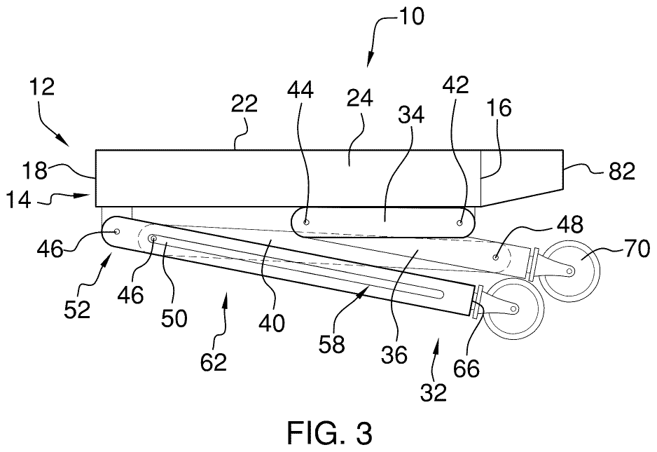

As depicted in FIG. 3, when one of the linkages 32 is in the collapsed configuration 62, the top front link 34 lies along the bottom side 20 of the upper platform 14, the bottom front link 36 lies closely to the upper platform 14, the back link 38 lies closely to the bottom front link 36, and the slider 50 of the bottom link 40 is positioned in the proximal position 52. As further shown in FIG. 3, the top front link 34 extends backwardly with respect to the upper platform 14 from the front platform pivot 42 to the front leg pivot 44, the bottom front link 36 extends forwardly with respect to the upper platform 14 from the front leg pivot 44 to the bottom pivot 48, and the back link 38 extends forwardly with respect to the upper platform 14 from the back platform pivot 46 to a distal end 64 of the back link 38 with respect to the upper platform 14. FIG. 2 shows the cart 12 when the linkages 32 are in the process of transitioning from the deployed configuration 60 to the collapsed configuration 62.

Each wheel of the plurality of wheels is coupled to an associated linkage 32 of the pair of linkages 32. The plurality of wheels includes a pair of back wheels 68 and a pair of front wheels 70. Each back wheel 68 is mounted to the distal end 64 of the back link 38 of the associated linkage 32, and each front wheel 70 is mounted to a distal end 66 of the bottom front link 36 of the associated linkage 32 with respect to the top front link 34 of the associated linkage 32. The wheels may comprise casters in some embodiments. In one embodiment, for example, the back wheels 68 comprise casters which may freely swivel with respect to their respective linkages 32 and the front wheels 70 are fixed against swiveling with respect to their respective linkages 32.

The linkages 32 are biased toward the deployed configuration 60. A pair of front torsion springs 72 is provided, wherein each front torsion spring 72 is mounted at the front platform pivot 42 of an associated linkage 32 of the pair of linkages 32 to bias the top front link 34 of the associated linkage 32 forwardly with respect to the upper platform 14. A pair of back torsion springs 74 is provided, wherein each back torsion spring 74 is mounted at the back platform pivot 46 of an associated linkage 32 of the pair of linkages 32 to bias the back link 38 of the associated linkage 32 backwardly with respect to the upper platform 14. Other biasing means may be used.

A locking mechanism is operatively coupled to the pair of linkages 32. The locking mechanism is configured to selectively fix the pair of linkages 32 in place. The locking mechanism comprises a pair of front locks 76 and a pair of back locks 78, where each front lock 76 and each back lock 78 is mounted to the upper platform 14 adjacent to an associated linkage 32 of the pair of linkages 32. Each front lock 76 is engageable with the top front link 34 of the associated linkage 32 to fix the top front link 34 with respect to the upper platform 14, and each back lock 78 is engageable with the back link 38 of the associated linkage 32 to fix the back link 38 with respect to the upper platform 14.

Each front lock 76 and each back lock 78 may comprise a clamp, a locking pin, a linear actuator, or the like. Each front lock 76 and each back lock 78 is biased to lockingly engage the front link and the back link 38 respectively of the associated linkage 32. The front locks 76 and the back locks 78 may be biased by springs, elastic bands, an electronic controller, or the like. An actuator input 80 is operatively coupled to the front locks 76 and the back locks 78. The actuator input 80 is selectively actuatable to release the front locks 76 and the back locks 78 from lockingly engaging the linkages 32. The actuator input 80 may be electrically coupled such that an electrical signal is sent to circuitry such as an electronic controller to release the front locks 76 and the back locks 78. In other embodiments, the actuator input 80 may be coupled hydraulically, via a Bowden cable, via a lever, via a geartrain, or any other suitable operative coupling to the front locks 76 and the back locks 78.

In other embodiments, the front locks 76 and the back locks 78 may be biased away from lockingly engaging the linkages 32, and the actuator input 80 may be operable to cause the front locks 76 and the back locks 78 to engage. In yet other embodiments, the front locks 76 and the back locks 78 may have no bias, and the actuator may alternately cause the front locks 76 and the back locks 78 to lockingly engage and disengage from the linkages 32.

A handle 82 is coupled to and spaced forwardly of the front side 16 of the upper platform 14. The handle 82 is elongated and extends laterally with respect to the upper platform 14. The actuator input 80 of the locking mechanism is mounted on the handle 82. A lower platform 84 is coupled to and extends between the bottom links 40 of the pair of linkages 32. The lower platform 84 is integrally formed with the bottom links 40 but may be separately formed in other embodiments. The lower platform 84 defines a recess 88 in a top surface 86 of the lower platform 84. Such that the lower platform 84 may support items upon a recessed surface 90 in the recess 88.

The receiver 92 for storing the cart 12 comprises a bottom wall 94 and a pair of lateral walls 96 coupled to and extending upwardly from the bottom wall 94. The receiver 92 further comprises a pair of top flanges 98, each of which is coupled to an associated lateral wall 96 of the pair of lateral walls 96 opposite the bottom wall 94. The top flanges 98 define a gap therebetween. The receiver 92 defines a bay 100 which is bounded by the bottom wall 94, the pair of lateral walls 96, and the pair of top flanges 98. The cart 12 may be positioned in a storage position with respect to the receiver 92 in which the linkages 32 of the cart 12 are in their respective collapsed configurations 62 and the cart 12 is positioned in the bay 100 of the receiver 92. While the cart 12 is positioned in the storage position, the upper platform 14 of the cart 12 is positioned adjacent to and under the top flanges 98 of the receiver 92.

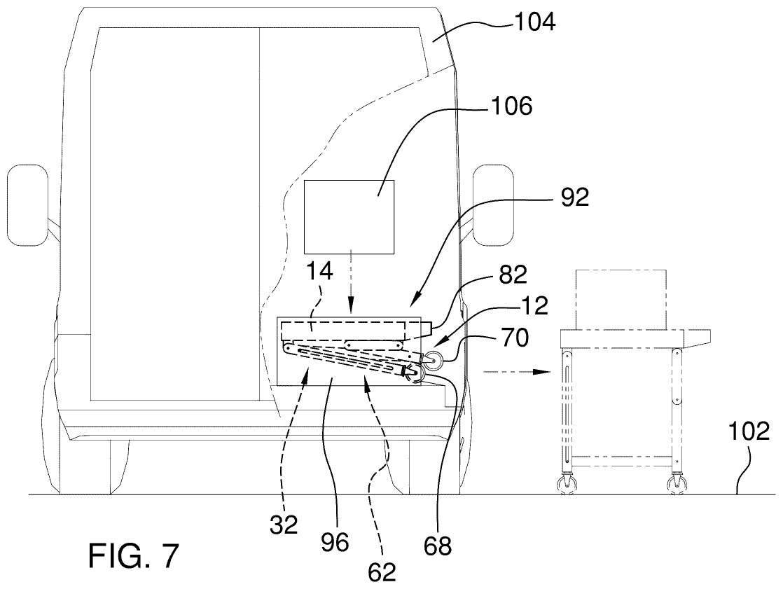

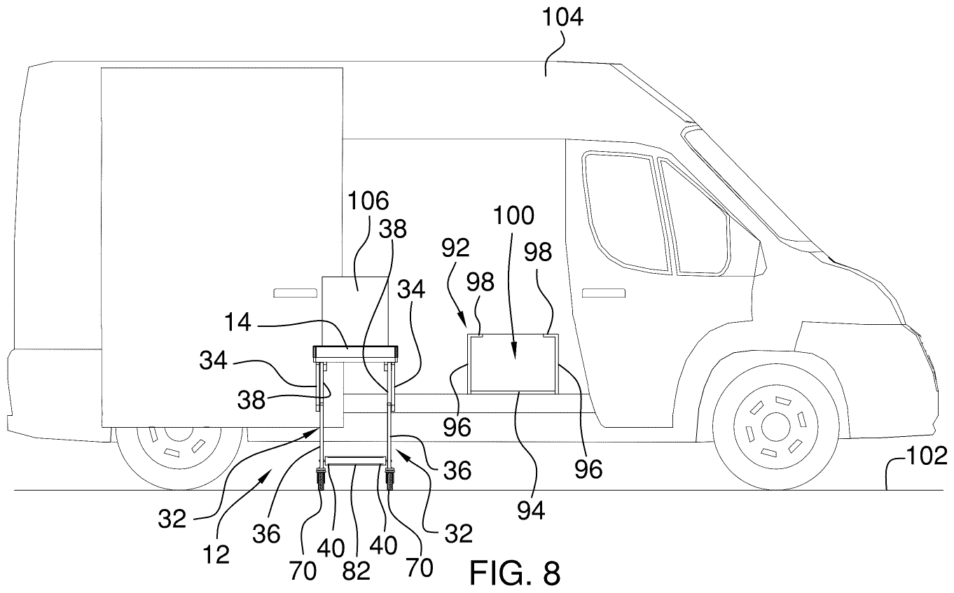

In use, the cart 12 may be rolled over a floor surface 102 via the wheels when the linkages 32 are in their deployed configurations 60 while carrying the load 106 on the upper platform 14. To place the cart 12 into the receiver 92, the actuator input 80 is actuated such that the lock mechanism releases the linkages 32, allowing them to be moved into the collapsed configurations 62 when sufficient forces are applied to counteract the bias from the front torsion springs 72 and the back torsion springs 74. Any items stored on the lower platform 84 would likely need to be removed before collapsing the cart 12. The cart 12 may then be inserted into the bay 100 of the receiver 92, where the load 106 may extend through the gap formed between the top flanges 98. The top flanges 98 secure the cart 12 in place, resisting the bias of the front torsion springs 72 and the back torsion springs 74. The receiver 92 may be mounted at a height relative to the floor surface 102 such that the upper platform 14 need not be raised or lowered when transitioning the linkages 32 of the cart 12 from their deployed configurations 60 to their collapsed configurations 62 to store the cart 12 in the bay 100 of the receiver 92. The receiver 92, for example and as shown in FIGS. 7 and 8, may also be mounted in a vehicle 104. Such a use facilitates easier loading and unloading of the load 106 to and from the vehicle 104.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible cart apparatus comprising:
an upper platform, the upper platform having a front side and a back side positioned opposite each other, a bottom side and a top side of the upper platform extending between the front side and the back side, a pair of lateral sides of the upper platform extending between the front side and the back side and between the bottom side and the top side;
a linkage coupled to the upper platform, the linkage comprising:
a top front link mounted to the bottom side of the upper platform at a front platform pivot, the top front link being pivotable alternately forward and backward with respect to the upper platform about the front platform pivot;
a bottom front link coupled to the top front link opposite the upper platform at a front leg pivot, the bottom front link being pivotable forward and backward with respect to the upper platform about the front leg pivot;
a back link mounted to the bottom side of the upper platform at a back platform pivot, the back platform pivot being spaced backwardly of the front platform pivot with respect to the upper platform, the back link being pivotable alternately forward and backward with respect to the upper platform about the back platform pivot; and
a bottom link coupled to and extending between the back link and the bottom front link, the bottom link being pivotable with respect to the bottom front link at a bottom pivot, the bottom link comprising a slider positioned distally from the bottom pivot, the slider being slidable along a length of the back link between a proximal position and a distal position with respect to the upper platform;
wherein the linkage is positionable in a deployed configuration, the deployed configuration including:
the top front link extending downwardly from the upper platform;
the bottom front link extending downwardly from the top front link with respect to the upper platform;
the back link extending downwardly from the upper platform; and
the slider of the bottom link being positioned in the distal position, the bottom link;
wherein the linkage is positionable in a collapsed configuration, the collapsed configuration including:
the top front link lying along the bottom side of the upper platform, the top front link extending backwardly with respect to the upper platform from the front platform pivot to the front leg pivot;
the bottom front link lying closely to the upper platform, the bottom front link extending forwardly with respect to the upper platform from the front leg pivot to the bottom pivot;
the back link lying closely to the bottom front link, the back link extending forwardly with respect to the upper platform from the back platform pivot to a distal end of the back link with respect to the upper platform; and
the slider of the bottom link being positioned in the proximal position; and
a plurality of wheels coupled to the linkage, the plurality of wheels being positioned on the linkage such that the plurality of wheels is configured to support the linkage and the upper platform on a floor surface when the linkage is in the deployed configuration.

2. The collapsible cart apparatus of claim 1, wherein:
the linkage is one of a pair of linkages coupled to the upper platform, the pair of linkages being laterally spaced from each other with respect to the upper platform, each linkage of the pair of linkages comprising:
a top front link mounted to the bottom side of the upper platform at a front platform pivot, the top front link being pivotable alternately forward and backward with respect to the upper platform about the front platform pivot;
a bottom front link coupled to the top front link opposite the upper platform at a front leg pivot, the bottom front link being pivotable forward and backward with respect to the upper platform about the front leg pivot;
a back link mounted to the bottom side of the upper platform at a back platform pivot, the back platform pivot being spaced backwardly of the front platform pivot with respect to the upper platform, the back link being pivotable alternately forward and backward with respect to the upper platform about the back platform pivot; and
a bottom link coupled to and extending between the back link and the bottom front link, the bottom link being pivotable with respect to the bottom front link at a bottom pivot, the bottom link comprising a slider positioned distally from the bottom pivot, the slider being slidable along a length of the back link between a proximal position and a distal position with respect to the upper platform;
wherein each linkage of the pair of linkages is positionable in a deployed configuration, the deployed configuration of each linkage including:
the top front link extending downwardly from the upper platform;
the bottom front link extending downwardly from the top front link with respect to the upper platform;
the back link extending downwardly from the upper platform; and
the slider of the bottom link being positioned in the distal position;
wherein each linkage of the pair of linkages is positionable in a collapsed configuration, the collapsed configuration of each linkage including:
the top front link lying along the bottom side of the upper platform, the top front link extending backwardly with respect to the upper platform from the front platform pivot to the front leg pivot;
the bottom front link lying closely to the upper platform, the bottom front link extending forwardly with respect to the upper platform from the front leg pivot to the bottom pivot;
the back link lying closely to the bottom front link, the back link extending forwardly with respect to the upper platform from the back platform pivot to a distal end of the back link with respect to the upper platform; and
the slider of the bottom link being positioned in the proximal position;
wherein each wheel of the plurality of wheels is coupled to an associated linkage of the pair of linkages, the plurality of wheels being positioned on the pair of linkages such that the plurality of wheels is configured to support the pair of linkages and the upper platform on the floor surface when the linkage is in the deployed configuration.

3. The collapsible cart apparatus of claim 2, wherein the plurality of wheels includes:
a pair of back wheels, each back wheel of the pair of back wheels being mounted to the distal end of the back link of the associated linkage; and
a pair of front wheels, each front wheel of the pair of front wheels being mounted to a distal end of the bottom front link of the associated linkage with respect to the top front link of the associated linkage.

4. The collapsible cart apparatus of claim 2, further comprising a lower platform coupled to and extending between the bottom links of the pair of linkages.

5. The collapsible cart apparatus of claim 4, wherein the lower platform defines a recess in a top surface thereof.

6. The collapsible cart apparatus of claim 4, wherein the lower platform is integrally formed with the bottom links of the pair of linkages.

7. The collapsible cart apparatus of claim 1, wherein the upper platform comprises a base wall and a perimeter wall coupled to the base wall, the upper platform defining a cavity surrounded by the base wall and the perimeter wall.

8. The collapsible cart apparatus of claim 1, further comprising a bias assembly, the bias assembly being operatively coupled to the linkage, the bias assembly being configured to bias the linkage toward the deployed configuration.

9. The collapsible cart apparatus of claim 8, wherein the bias assembly comprises:
a front torsion spring mounted at the front platform pivot of the linkage to bias the top front link of the linkage forwardly with respect to the upper platform; and
a back torsion spring mounted at the back platform pivot of the linkage to bias the back link of the linkage backwardly with respect to the upper platform.

10. The collapsible cart apparatus of claim 1, further comprising a locking mechanism operatively coupled to the linkage, the locking mechanism being configured to selectively fix the linkage in place.

11. The collapsible cart apparatus of claim 10, wherein the locking mechanism comprises:
a front lock mounted to the upper platform adjacent to the linkage, the front lock being engageable with the top front link of the linkage to fix the top front link with respect to the upper platform;
a back lock mounted to the upper platform adjacent to the linkage, the back lock being engageable with the back link of the linkage to fix the back link with respect to the upper platform; and
an actuator input operatively coupled to the pair of front locks and the pair of back locks.

12. The collapsible cart apparatus of claim 11, wherein:
the front lock is biased to lockingly engage the top front link of the linkage; and
the back lock is biased to lockingly engage the back link of the linkage.

13. The collapsible cart apparatus of claim 1, further comprising a handle coupled to and spaced forwardly of the front side of the upper platform, the handle being elongated and extending laterally with respect to the upper platform.

14. A collapsible cart apparatus comprising:
an upper platform, the upper platform having a front side and a back side positioned opposite each other, a bottom side and a top side of the upper platform extending between the front side and the back side, a pair of lateral sides of the upper platform extending between the front side and the back side and between the bottom side and the top side, the upper platform comprising a base wall and a perimeter wall coupled to the base wall, the upper platform defining a cavity surrounded by the base wall and the perimeter wall;
a pair of linkages coupled to the upper platform, the pair of linkages being laterally spaced from each other with respect to the upper platform, each linkage of the pair of linkages comprising:
a top front link mounted to the bottom side of the upper platform at a front platform pivot, the top front link being pivotable alternately forward and backward with respect to the upper platform about the front platform pivot;
a bottom front link coupled to the top front link opposite the upper platform at a front leg pivot, the bottom front link being pivotable forward and backward with respect to the upper platform about the front leg pivot;
a back link mounted to the bottom side of the upper platform at a back platform pivot, the back platform pivot being spaced backwardly of the front platform pivot with respect to the upper platform, the back link being pivotable alternately forward and backward with respect to the upper platform about the back platform pivot; and
a bottom link coupled to and extending between the back link and the bottom front link, the bottom link being pivotable with respect to the bottom front link at a bottom pivot, the bottom link comprising a slider positioned distally from the bottom pivot, the slider being slidable along a length of the back link between a proximal position and a distal position with respect to the upper platform;
wherein each linkage of the pair of linkages is positionable in a deployed configuration, the deployed configuration of each linkage including:
the top front link extending downwardly from the upper platform;
the bottom front link extending downwardly from the top front link with respect to the upper platform;
the back link extending downwardly from the upper platform; and
the slider of the bottom link being positioned in the distal position;
wherein each linkage of the pair of linkages is positionable in a collapsed configuration, the collapsed configuration of each linkage including:
the top front link lying along the bottom side of the upper platform, the top front link extending backwardly with respect to the upper platform from the front platform pivot to the front leg pivot;
the bottom front link lying closely to the upper platform, the bottom front link extending forwardly with respect to the upper platform from the front leg pivot to the bottom pivot;
the back link lying closely to the bottom front link, the back link extending forwardly with respect to the upper platform from the back platform pivot to a distal end of the back link with respect to the upper platform; and
the slider of the bottom link being positioned in the proximal position;
a plurality of wheels, each wheel of the plurality of wheels being coupled to an associated linkage of the pair of linkages, the plurality of wheels including:
a pair of back wheels, each back wheel of the pair of back wheels being mounted to the distal end of the back link of the associated linkage; and
a pair of front wheels, each front wheel of the pair of front wheels being mounted to a distal end of the bottom front link of the associated linkage with respect to the top front link of the associated linkage;
a pair of bias assemblies, each bias assembly of the pair of bias assemblies being operatively coupled to an associated linkage of the pair of linkages, each bias assembly being configured to bias the associated linkage toward the deployed configuration, each bias assembly of the pair of bias assemblies comprising:
a front torsion spring mounted at the front platform pivot of the associated linkage to bias the top front link of the associated linkage forwardly with respect to the upper platform; and
a back torsion spring mounted at the back platform pivot of the associated linkage to bias the back link of the associated linkage backwardly with respect to the upper platform;
a locking mechanism operatively coupled to the pair of linkages, the locking mechanism being configured to selectively fix the pair of linkages in place, the locking mechanism comprising:
a pair of front locks, each front lock of the pair of front locks being mounted to the upper platform adjacent to an associated linkage of the pair of linkages, each front lock of the pair of front locks being engageable with the top front link of the associated linkage to fix the top front link with respect to the upper platform, each front lock of the pair of front locks being biased to lockingly engage the top front link of the associated linkage;
a pair of back locks, each back lock of the pair of back locks being mounted to the upper platform adjacent to an associated linkage of the pair of linkages, each back lock of the pair of back locks being engageable with the back link of the associated linkage to fix the back link with respect to the upper platform, each back lock of the pair of back locks being biased to lockingly engage the back link of the associated linkage; and
an actuator input operatively coupled to the pair of front locks and the pair of back locks;
a handle coupled to and spaced forwardly of the front side of the upper platform, the handle being elongated and extending laterally with respect to the upper platform, the actuator input of the locking mechanism being mounted on the handle; and
a lower platform being coupled to and extending between the bottom links of the pair of linkages, the lower platform defining a recess in a top surface thereof, the lower platform being integrally formed with the bottom links of the pair of linkages.

15. A material handling system comprising:
a cart comprising:
an upper platform, the upper platform having a front side and a back side positioned opposite each other, a bottom side and a top side of the upper platform extending between the front side and the back side, a pair of lateral sides of the upper platform extending between the front side and the back side and between the bottom side and the top side, the upper platform comprising a base wall and a perimeter wall coupled to the base wall, the upper platform defining a cavity surrounded by the base wall and the perimeter wall;
a pair of linkages coupled to the upper platform, the pair of linkages being laterally spaced from each other with respect to the upper platform, each linkage of the pair of linkages comprising:
a top front link mounted to the bottom side of the upper platform at a front platform pivot, the top front link being pivotable alternately forward and backward with respect to the upper platform about the front platform pivot;
a bottom front link coupled to the top front link opposite the upper platform at a front leg pivot, the bottom front link being pivotable forward and backward with respect to the upper platform about the front leg pivot;
a back link mounted to the bottom side of the upper platform at a back platform pivot, the back platform pivot being spaced backwardly of the front platform pivot with respect to the upper platform, the back link being pivotable alternately forward and backward with respect to the upper platform about the back platform pivot; and
a bottom link coupled to and extending between the back link and the bottom front link, the bottom link being pivotable with respect to the bottom front link at a bottom pivot, the bottom link comprising a slider positioned distally from the bottom pivot, the slider being slidable along a length of the back link between a proximal position and a distal position with respect to the upper platform;
wherein each linkage of the pair of linkages is positionable in a deployed configuration, the deployed configuration of each linkage including:
the top front link extending downwardly from the upper platform;
the bottom front link extending downwardly from the top front link with respect to the upper platform;
the back link extending downwardly from the upper platform; and
the slider of the bottom link being positioned in the distal position;
wherein each linkage of the pair of linkages is positionable in a collapsed configuration, the collapsed configuration of each linkage including:
the top front link lying along the bottom side of the upper platform, the top front link extending backwardly with respect to the upper platform from the front platform pivot to the front leg pivot;
the bottom front link lying closely to the upper platform, the bottom front link extending forwardly with respect to the upper platform from the front leg pivot to the bottom pivot;
the back link lying closely to the bottom front link, the back link extending forwardly with respect to the upper platform from the back platform pivot to a distal end of the back link with respect to the upper platform; and
the slider of the bottom link being positioned in the proximal position;
a plurality of wheels, each wheel of the plurality of wheels being coupled to an associated linkage of the pair of linkages, the plurality of wheels including:
a pair of back wheels, each back wheel of the pair of back wheels being mounted to the distal end of the back link of the associated linkage; and
a pair of front wheels, each front wheel of the pair of front wheels being mounted to a distal end of the bottom front link of the associated linkage with respect to the top front link of the associated linkage;
a pair of bias assemblies, each bias assembly of the pair of bias assemblies being operatively coupled to an associated linkage of the pair of linkages, each bias assembly being configured to bias the associated linkage toward the deployed configuration, each bias assembly of the pair of bias assemblies comprising:
a front torsion spring mounted at the front platform pivot of the associated linkage to bias the top front link of the associated linkage forwardly with respect to the upper platform; and
a back torsion spring mounted at the back platform pivot of the associated linkage to bias the back link of the associated linkage backwardly with respect to the upper platform;
a locking mechanism operatively coupled to the pair of linkages, the locking mechanism being configured to selectively fix the pair of linkages in place, the locking mechanism comprising:
a pair of front locks, each front lock of the pair of front locks being mounted to the upper platform adjacent to an associated linkage of the pair of linkages, each front lock of the pair of front locks being engageable with the top front link of the associated linkage to fix the top front link with respect to the upper platform, each front lock of the pair of front locks being biased to lockingly engage the top front link of the associated linkage;
a pair of back locks, each back lock of the pair of back locks being mounted to the upper platform adjacent to an associated linkage of the pair of linkages, each back lock of the pair of back locks being engageable with the back link of the associated linkage to fix the back link with respect to the upper platform, each back lock of the pair of back locks being biased to lockingly engage the back link of the associated linkage; and
an actuator input operatively coupled to the pair of front locks and the pair of back locks;
a handle coupled to and spaced forwardly of the front side of the upper platform, the handle being elongated and extending laterally with respect to the upper platform, the actuator input of the locking mechanism being mounted on the handle; and
a lower platform being coupled to and extending between the bottom links of the pair of linkages, the lower platform defining a recess in a top surface thereof, the lower platform being integrally formed with the bottom links of the pair of linkages;
a receiver for storing the cart, the receiver comprising a bottom wall and a pair of lateral walls coupled to and extending upwardly from the bottom wall, the receiver further comprising a pair of top flanges, each top flange of the pair of top flanges being coupled to an associated lateral wall of the pair of lateral walls opposite the bottom wall, the pair of top flanges defining a gap therebetween, the receiver defining a bay bounded by the bottom wall, the pair of lateral walls, and the pair of top flanges; and
wherein the cart is positionable in a storage position in which the cart is positioned in the bay of the receiver, each linkage of the pair of linkages of the cart being positioned in the collapsed configuration when the cart is in the storage position, the upper platform of the cart being positioned adjacently under the top flanges of the receiver when the cart is in the storage position.
